(19) United States
(12) Patent Application Publication
(10) Pub. No.: US 2007/0184283 A1
(43) Pub. Date: Aug. 9, 2007

(54) Glass Structure and Method of Making the Same

(76) Inventors: Jean D. Breshears, Lockport, IL (US); Joseph W. Chavis, Faribault, MN (US); Willliam A. Meredith, Faribault, MN (US); Daniel P. Woodruff, Lakeville, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/620,971

(22) Filed: Jan. 8, 2007

Related U.S. Application Data
(60) Provisional application No. 60/757,802, filed on Jan. 10, 2006.

(51) Int. Cl. B32B 17/06; B05D 5/06; B32B 9/00

(52) U.S. Cl. 428/426; 428/429; 427/162

(57) ABSTRACT

A method of making coated glass structure including providing a glass substrate wherein the glass substrate exhibits a color which is off neutral, and applying a coating to the glass substrate wherein the coating comprises a colorant capable of at least partially neutralizing the color. A glass structure including a glass substrate having a pair of major surfaces wherein the glass substrate exhibits a color which is off neutral, and a coating applied to at least one of the major surfaces wherein the coating exhibits a color which at least partially neutralizes the color of the glass substrate.

### CROSS REFERENCE TO RELATED APPLICATIONS

This application claims priority to U.S. application Ser. No. 60/757802, filed Jan. 10, 2006, the contents of which are incorporated herein by reference in their entirety.

### FIELD OF THE INVENTION

The present invention relates generally to a glass structure and method of making the same and more specifically to a glass structure simulating so-called “clear glass” and a method for making the same.

### BACKGROUND OF THE INVENTION

Most glass produced today is produced by the float process in which glass raw materials (primarily silica sand, soda ash and limestone) are first weighed, mixed and conveyed to a melting furnace. The molten glass then flows continuously from the furnace onto a bath of molten tin where the glass floats and is pulled and stretched to the desired thickness. Standard float glass made via the float process normally has a greenish or off-neutral color tint which can be seen best by looking at the edge of a piece of glass. This greenish or off-neutral color tint is due primarily to the existence of impurities such as iron in the raw materials.

While standard float glass is totally acceptable for many applications, there is a need for so-called “clear glass” in which the greenish or off-neutral color tint has been removed or reduced. Such clear glass compositions are useful, for example, in architectural windows, patterned glass applications, solar cells, automotive windows and picture or artwork framing, among others. One known method of achieving clear glass is to purify the raw materials prior to manufacture of the glass by removing impurities such as iron which cause standard float glass to have a greenish or off-neutral color tint. However, providing raw materials with a high degree of purity is quite expensive and thus involves certain practical and/or economical limits. Other known processes for manufacturing clear glass include adding various chemical ingredients to the glass composition which convert or oxidize the iron to a weaker colorant form. Examples of clear glass compositions and methods of forming the same are described in U.S. Pat. No. 6,949,484 and U.S. published Patent Applications Nos. 2004/0180775, 2004/0209757 and 2005/0188725.

Accordingly, there is a need in the art for a clear glass structure, or a simulation thereof, and a method of making the same.

### BRIEF SUMMARY OF THE INVENTION

The present invention surprisingly provides a glass structure which closely simulates so called “clear glass” and accordingly can be used in many applications interchangeably with clear glass manufactured by conventional methods. The invention also relates to a method of manufacturing such a glass structure.

More specifically, the present invention involves at least partially neutralizing the greenish color or off-neutral color of standard float glass by applying a coating to the glass sheet in which the coating includes a colorant capable of at least partially neutralizing the off-neutral color tint of the glass sheet. Because standard float glass normally exhibits a greenish tint, it has been found that by applying a coating that contains an effective amount of a combination of dyes or other colorants such as an effective amount of a combination of red and blue dyes will tend to neutralize the green tint and provide a glass structure which more closely resembles or simulates clear glass.

The invention contemplates applying the colored or tinted coating either by itself or as part of a further standard glass coating. In particular, applying the colored or tinted coating as part of a standard glass coating eliminates the need for an extra coating step. More particularly, a standard ultraviolet (UV) coating is applied in which the coating is provided with dyes or other colorants that are effective to substantially or at least partially neutralize the off-neutral tint of the standard glass.

Typically, such UV or other coatings often have a color or off-neutral tint of their own when applied to a glass substrate. This is particularly true of ultraviolet (UV) coatings which, because of their ability to block out or absorb UV wavelengths, also absorb some of the wavelengths in the blue region of the visible spectrum. If a portion of the blue region of the visible spectrum is absorbed by the UV coating in preference to the red and green regions, the coating will take on a yellow color.

Even if techniques are used to reduce the yellow color of UV coatings, as described in U.S. Pat. No. 5,371,138, incorporated by reference in its entirety, the UV coated standard float glass continues to exhibit a greenish tint. The greenish tint is due in large part to the inherent greenish tint of the underlying standard glass substrate. Therefore, a need exists for a glass structure and/or a method to apply UV coatings to standard float glass which will result in lower manufacturing costs and/or substantial clarity of glass in many applications that continue to apply UV coatings to the more expensive so called clear or extra clear glass.

Accordingly, the glass structure of the present invention includes a standard, green glass substrate exhibiting a color which is off neutral (generally a greenish tint) to which a coating is applied to at least partially neutralize the off-neutral color of the glass substrate. In particular, the coating is an ultraviolet (UV) coating which includes not only dyes or other colorants to at least partially correct or neutralize the inherent off-neutral color of the UV coating itself, but also dyes or other colorants to at least partially correct or neutralize the off-neutral color of the underlying glass substrate.

In general, the method of the present invention includes providing a standard glass substrate which exhibits an off-neutral color and applying a coating to the substrate in which the coating includes a colorant capable of at least partially correcting or neutralizing the off-neutral color of the underlying substrate. In a particular method, the coating is a UV coating which is designed to block transmission of UV radiation. Colorant is added to the coating to not only at least partially correct or neutralize the inherent off-neutral color of the UV coating, but also to at least partially correct or neutralize the off-neutral color of the underlying glass substrate.

More particularly, the method includes measuring or evaluating the off-neutral color of the glass substrate or the glass substrate with conventional UV or other coating, adding colorant to a coating composition in an amount, and of a color, effective to at least partially correct or neutralize the off-neutral color of the substrate or the off-neutral color of the substrate and conventional coating, and then applying the coating composition to the substrate.

The present invention provides a glass structure and method of making the same which substantially simulates UV coated clear glass.

The present invention also provides a coated glass substrate in which the coating is provided with dyes or other colorants to substantially neutralize the off-neutral color of glass substrate.

The present invention further provides a method for making a glass structure which substantially neutralizes the off-neutral color of a standard float glass substrate.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the detailed descriptions are to be regarded as illustrative in nature and not restrictive.

### BRIEF DESCRIPTION OF THE DRAWINGS

The accompanying drawing is included to provide a further understanding of the present invention and is incorporated in and constitute part of this specification.

FIG. 1 is a CIELab color diagram.

### DETAILED DESCRIPTION OF THE INVENTION

The present invention is directed to a glass substrate which simulates or substantially simulates so-called “clear glass” and a method of treating a glass substrate to result in a glass structure simulating or substantially simulating “clear glass”.

In the specification and in the claims, the terms “including” and “comprising” are open-ended terms and should be interpreted to mean “including, but not limited to . . . .” These terms encompass the more restrictive terms “consisting essentially of” and “consisting of.”

Unless otherwise defined herein, the use of the terms “clear glass” or “standard clear glass” or “extra clear glass” shall refer to glass (such as float glass) in which impurities have been removed or which has been treated during the manufacturing process or otherwise to at least partially remove or correct the off-neutral color tint inherent in standard float glass.

The terms “standard float glass” or “standard green glass” shall refer to glass (such as float glass) which has not been treated or otherwise processed to produce “clear glass” and exhibits an off-neutral color.

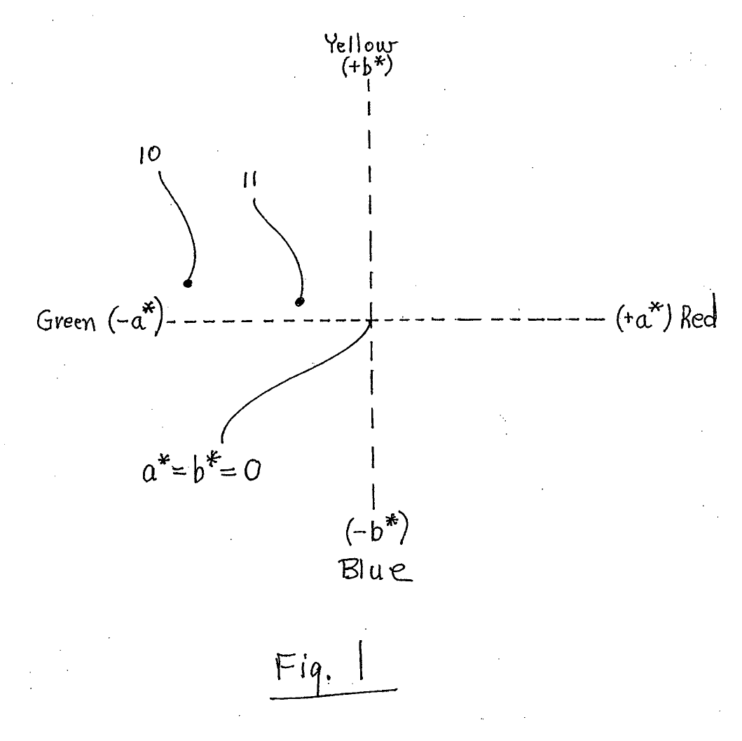

The term “neutral” or “off neutral” as used herein in connection with the color tint of a glass substrate or glass structure shall refer to the level of color exhibited by such glass substrate or glass structure. In a CIELab color model known to those skilled in the art and represented by the CIELab diagram of FIG. 1, a totally neutral color would be at the center of the CIELab diagram in which a*=b*=0. An “off-neutral” color would be a color on the CIELab diagram in which either a* or b*, or both, are not 0. Normally, standard float glass has an inherent greenish tint or greenish-yellowish tint or hue represented by a color point along the −a* coordinate or in the −a*/+b* quadrant of the CIELab diagram.

The terms “a*” and “b*” refer to the axes as shown in the CIELab diagram of FIG. 1. a* represents the red-green axis and b* represents the yellow-blue axis. A positive a* value is red, and a negative a* value is green. A positive b* value is yellow, and a negative b* value is blue. The magnitude of the values represent the chroma along each axis. The a*,b* paired value taken together describes a color hue.

The CIELab color model is the CIE 1976 L* a* b* color coordinate system with a D65 illuminant and 10° observer. The methods of use are described in ISO/CIE 10526 “CIE Standard Illuminants for Colorimetry,” ISO/CIE 10527 “Colorimetric Observers,” ASTM D2244 “Standard Practice for Calculation of Color Tolerances and Color Differences from Instrumentally Measured Color Coordinates,” and ASTM E1347 “Standard Test Method for Color and Color-Difference Measurement by Tristimulus (Filter) Colorimetry.”

Accordingly, the terms “neutralize”, “partially neutralize” or “substantially neutralize” shall mean shifting the color point of an “off-neutral” color toward “neutral”. The third or “z” axis of the CIELab diagram is orthogonal to both the “a*” and “b*” axes and represents “L*”. In the CIELab diagram, L* is a measure of the lightness or intensity of the color. Thus, when a*=b*=0, L* represents the scale of grays from 0 (black) to 100 (white). When a* and/or b* values are other than zero, then L* describes lightness, the degree of color saturation, of a given color hue as described by the a*,b* pair. Accordingly, an off-neutral color of a transparent or substantially transparent substrate such as a sheet of glass can be graphically and numerically represented by an L*a*b* value in which L* represents lightness or intensity and a* and b* represent shades of colors on the CIELab diagram.

The term “UV coating” shall refer to a coating designed to block or partially block transmission of ultraviolet (UV) radiation.

The term “colorant” shall include pigments and dyes that are recognized in the art and include those dyes such as ORASOL® dyes, which are commonly known as solvent soluble organic dyes.

In accordance with the present invention, a glass substrate is provided in which the glass substrate is standard float glass (or sometimes referred to as “standard green glass”) and in which the substrate exhibits an off-neutral color or tint. Generally, this off-neutral color is a greenish or greenish-yellowish tint or hue, which, for example is represented on the diagram of FIG. 1 by the color point 10. By applying a coating to a major surface of the glass substrate in which certain dyes or other colorants have been added to the coating composition, the off-neutral color or tint of the glass substrate can be at least partially corrected or neutralized.

For example, with standard float glass exhibiting a greenish or greenish-yellowish hue, a coating with a combination of red and blue dyes or other colorants (represented by +a* and −b* on the CIELab diagram), the inherent greenish or greenish-yellowish tint of the glass substrate will be shifted toward the center (or neutral color point) of the CIELab diagram, such as, for example, at color point 11 on the diagram of FIG. 1.

It is recognized that it is generally not necessary or desirable to totally correct or neutralize the off-neutral color of the glass substrate, since the addition of dyes or other colorants to a glass coating will tend to reduce the light transmission through the glass. Thus, in particular it is desirable to add sufficient colorant to at least partially correct or neutralize the off-neutral color of the substrate resulting from the glass substrate but not enough to adversely affect light transmission beyond commercially acceptable standards. The lightness (or darkness) of the transmitted light through a coated glass substrate is represented by L* in the L*a*b* value. Although what is commercially acceptable as an L* value for coated glass, or UV coated glass, will vary depending upon the particular application, an L* value greater than 92, particularly greater than 94, and more particularly greater than 95 is commercially acceptable for some applications.

It is contemplated that the coating to be applied to the glass substrate generally is a colorant containing coating in which the only function of the coating is to carry the dye or other colorant to at least partially neutralize the off-neutral color of the glass substrate. However, the invention also has particular applicability to glass structures which are normally provided with a coating for other reasons such as coatings to provide UV shielding, coatings to provide anti-reflective (AR) properties, coatings to protect the surface of the glass substrate and coatings to provide hydrophobic properties to the substrate, among others. In particular, a method is described with respect to a glass substrate which is coated with an ultraviolet (UV) coating. More specifically, the invention relates to a glass substrate in accordance with or similar to that described and disclosed in U.S. Pat. No. 5,371,138, incorporated by reference in its entirety. The '138 patent relates to a UV blocking composition in which a color correcting dye is included in the composition to neutralize the normally yellowish coloring of the UV coating. Such patent, however, does not contemplate or address correcting or neutralizing the off-neutral green color tint resulting from the glass substrate on which the UV coating is applied. Such patent only addresses a yellow color tint resulting from the UV coating.

Accordingly, a first or initial step in a particular process of the present invention is to measure or evaluate the off-neutral color of the glass substrate or the glass substrate with conventional UV or other coating applied thereto. This generally is done with a variety of color measuring devices such as various spectrophotometers or calorimeters. With such color measuring instrument, the level or degree of the off-neutral color of the uncoated or conventionally coated glass substrate can be determined. Particularly, such measurements are graphically or otherwise represented such as by a color point on a CIELab diagram of the type illustrated in FIG. 1. Normally, for standard float glass, or standard UV coated float glass, this point is in the −a*/+b* quadrant of the diagram or along the −a* coordinate of the diagram. Thus, the color or tint of transmitted light through the substrate or coated substrate can be represented by an L*a*b*, with L*, a* and b* values representing values on their respective coordinates. In some cases, it is also possible to visually measure or evaluate the off-neutral tint of a coated or uncoated glass substrate.

In general, through measurement using a color measuring instrument, a spectrophotometer or calorimeter, standard green glass coated with a conventional UV blocking coating similar to that of U.S. Pat. No. 5,371,138 has an L*a*b* with an L* value of about 96.0, or in the range of about 95.5 to 96.5, an a* value of about −1.3, or in the range of about −1.5 to −1.2 and a b* value of about +1.1, or in the range of about +0.8 to +1.3. One such instrument is the HUNTERLAB™ UltraScan XE Colorimeter, available from Hunter Associates Laboratory, Reston, Va.

In contrast, standard clear glass which is coated with a conventional UV coating similar to that of U.S. Pat. No. 5,371,138 has an L*a*b* with an L* value of about 96.3, or in the range of about 95.8 to 96.8, an a* value of about −0.9, or in the range of about −1.3 to −0.5 and a b* value of about +1.3, or in the range of about +0.8 to +1.5. Standard clear glass coated with a conventional UV coating as provided above is commercially preferred for many applications. Thus, to meet customer demand for these applications, it is necessary to apply the UV coating to the more expensive clear glass rather than the less expensive green glass. The present invention provides neutralization of the greenish or off-neutral color of the standard green glass substrate to the degree where the resulting glass structure is comparable in optical properties to UV coated clear glass, while still maintaining commercially acceptable light transmission (L*).

A next step in the particular process is to provide one or more dyes or colorants to a coating composition which have the effect of at least partially correcting or neutralizing the off-neutral color of the standard green glass substrate to which the coating composition is applied. Because normal green glass has a greenish or greenish-yellowish tint or hue, an effective amount of a combination of red and/or blue dyes or other colorants in the coating composition will tend to shift the off-neutral greenish or greenish-yellowish color of the glass substrate toward neutral. A variety of dyes or other colorants can be used for this purpose. The Colour Index is an international classification system of dyes and pigments. In particular, solvent soluble organic dyes such as a cobalt complex dye having the Colour Index number Solvent Red 125 and a copper phthalocyanine derivative dye having the Colour Index number Solvent Blue 67 are used. More particularly, the red colorant used is ORASOL® Red G dye, while the blue colorant is ORASOL® Blue GN dye. ORASOL® dyes are available from Ciba Geigy Corporation, Hawthorne, N.Y. These dyes are added to the coating during formulation and mixing of the coating composition. Thus, when applied to the glass substrate, the colorants are totally and homogeneously dispersed throughout the coating and function to at least partially correct or neutralize the off-neutral tint of the underlying glass substrate.

The base composition of the coating typically includes a resin, in particular a polysiloxane resin, and also includes ultraviolet-absorbing materials. More particularly, resin compositions useful for carrying the colorants of the present invention are described in U.S. Pat. No. 5,371,138, incorporated by reference in its entirety.

Resin compositions generally comprise: (a) a base resin including (i) about 5 to 75 weight percent, based on the total solids of (a), of colloidal silica; (ii) about 0 to 50 weight percent, based on the total solids of (a), of a partial condensate of a silanol selected from the group of silanols having the formula Rw Si(OH)x or Ry Si(OR′)z where (w+x) or (y+z)=4, and R and R′ are organic radicals without any crosslinking sites; and (iii) about 10 to 55 weight percent, based on the total solids of (a), of a partial condensate of a silanol having the formula R″Si(OR′″)₃ where R″ is a hydrogen atom or an organic radical and R′″ is an organic radical containing a crosslinking site; (b) about 1 to 20 weight percent, based on the total solids of (a), of an ultraviolet-absorbing material; and (c) about 5 to 50 percent by volume, based on the volume of the resin composition, of an additive having a boiling point greater than or equal to about 189° C.

Ultraviolet-absorbing materials generally are selected from organic chemical groups including benzophenones, benzothiazoles and benzotriazoles. A preferred material is 2,2′,4,4′tetrahydroxy-benzophenone. The compounds 2-hydroxy-4-methoxy-benzophenone; 2,4-dihydroxybenzophenone; and 2-(2′-hydroxy-3,5′-di-tertamylphenyl) benzotriazole have also been successfully incorporated in resin compositions.

Additives having a boiling point greater than 189° C. generally include a material selected from the group consisting of glycols, glycol ethers, polyglycol ethers, and high boiling point alcohols. In general, a glycol additive is preferred. A preferred glycol is hexylene glycol having a boiling point of 198° C.

In a particular embodiment, the resin composition comprises a base resin (a) including (i) about 39 weight percent, based on the total solids of (a), of colloidal silica; (ii) about 16 weight percent, based on the total solids of (a), of a partial condensate of a silanol having the formula CH₃Si(OCH3)₃ and about 23 weight percent, based on the total solids of (a), of a partial condensate of a silanol having the formula 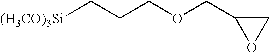
(iii) about 14 weight percent, based on the total solids of (a), of 2,2′,4,4′tetrahydroxybenzophenone; and (iv) about 5 to 55 percent by volume, based on the volume of the composition, of hexylene glycol.

A process for preparing the resin composition which significantly influences the suitability of the resin for roll coating has been developed. The process generally also influences the ultraviolet-absorbing properties of a cured resin layer made with the resin composition. The order and method in which constituents of a resin formulation are blended and reacted has been found particularly important in providing optimum ultraviolet-absorbing properties.

A preferred process of preparing a resin composition is set forth in detail below. The process is described in terms of the materials of the above-described preferred resin composition. The process is, however, applicable to other compositions defined by the above-described general specification of the resin composition.

Predetermined proportions of the silanols glycidoxypropyl-trimethoxysilane and methyltrimethoxysilane are combined, in a heat jacketed reaction vessel, or a vessel including heat transfer coils to form a silanol blend. The heat transfer coils, for example, generally are electrically heated or heated by a hot fluid or a vapor such as steam. The silanol blend is warmed to a temperature between about 100° F. and 150° F., preferably to a temperature of about 120° F. This first blend is agitated at a high speed. The blend generally is agitated by a rotary mechanical dispersion mixer commonly used in the art. The agitation speed generally is between about between about 500 and 1500 revolutions per minute (r.p.m). The blend is preferably continuously agitated.

A predetermined proportion of a water-based colloidal, silica is added to the silanol blend. The silica can be added as the silanol blend is agitated. Preferably, the agitation is continuous. The colloidal silica preferably has an acidic pH value. The pH value can be between about 2.5 and 3.0. The combination of the colloidal silica and the silanol blend is generally referred to as a silica-silanol or second blend.

The combination of the silanol blend and the colloidal silica produces an exothermic reaction. Methyl alcohol is generated as reaction product.

The silica-silanol blend is raised to a temperature of about 150° F. The blend is preferably held at 150° F. for at least one hour. The silica-silanol blend is then allowed to cool to a temperature of about 140° F. It is preferably held at that temperature for at least 6 hours. The silica-silanol blend should be agitated during the reaction period. Preferably, the agitation is continuous.

Between about fifty and ninety percent of a predetermined proportion of hexylene glycol is added to the silica-silanol blend. The blend should be agitated and the temperature maintained during the addition of the glycol. Preferably, the blend should be continually agitated.

The silica-silanol blend including the hexylene glycol is generally referred to as the silica-silanol-glycol or third blend.

Next, a predetermined proportion of 2,2′,4,4′tetrahydroxy-benzophenone is added to the silica-silanolglycol blend. The blend should be agitated and the temperature of about 140° F. maintained during the addition of the 2,2′,4,4′tetrahydroxybenzophenone. Preferably the agitation and the temperature are maintained for a total time of at least one hour. The resulting blend is generally referred to as a silica-silanol-glycol-benzophenone or fourth blend. The blend preferably should be continually agitated during the addition. It has been found that last described process step is important in promoting what is believed to be a substitution reaction between epoxy functionality of the silanol and hydroxyl groups in the UV absorbing material.

The process is completed by cooling the silica-silanol-glycol-benzophenone blend to room temperature and adding the remaining fraction of the hexylene glycol to form the final resin composition. Agitation is preferably continued during cooling.

One or more colorants or dyes, are added during the process of making the base composition. Colorants are typically available in powder or in liquid form. In particular, the dyes of the present invention are dispersed in resin composition additives such as glycols, glycol ethers, polyglycol ethers, and high boiling point alcohols, before they are added to the composition. More particularly, powdered dyes are pre-dispersed in methanol or propylene glycol before adding them to the composition.

The colorants can be added during different stages of the coating composition's manufacturing process, and in particular can be added to the composition as a last step before completion of the manufacturing process, and more particularly can be post-added with mixing after the manufacturing process of the base composition has been completed.

Various methods exist for determining the amount of color correction or neutralization needed or desired, and thus the amount of red and/or blue colorant which needs to be added to the coating composition, to provide the desired end color or to neutralize the off-neutral color to the desired extent. The amount of red and/or blue colorant added to a unit volume of coating reflects the concentration of the red and/or blue colorants in the coating composition. In general, the greater the concentration of red and/or blue colorants in the coating, the more the off-neutral greenish or greenish-yellowish tint of the glass substrate will be corrected or shifted toward neutral. However, as the concentration of neutralizing colorants increases, the light transmission properties or intensity (L*) of the coated substrate will be adversely affected, i.e., become darker. Thus, the present invention contemplates at least partially neutralizing the off-neutral color of the glass substrate to a point which is visually acceptable or which results in a visually acceptable simulation of clear glass, but not to the point that it results in a glass structure in which the light transmission is commercially unacceptable.

Application processes such as spray coating, dip coating, roll coating or curtain coating are useful for applying the coating composition to a glass substrate. In particular, a roll coating process is used. Standard and custom roll coating equipment is available from Black Brothers, Mendota, Ill.

The color neutralizing effect and the light transmission properties of a tinted coating can be affected by the thickness of the coating applied to the substrate. To provide sufficient UV blocking, conventional UV coatings are applied to yield thicknesses ranging from about 0.7 microns to about 5.0 microns. Thus, coatings such as UV coatings which have been color corrected in accordance with the present invention should particularly have a thickness of about 0.7 microns to 5.0 microns, and more particularly about 1.8 microns to about 3.1 microns. These measurements reflect cured film thicknesses. Measurements of wet film thicknesses have higher values, up to about 10 microns, in particular, about 4.0 to about 7.0 microns depending on the amount of total solids in the coating compositions. Coatings whose only function is to correct for the off-neutral color of standard green glass generally have a minimal thickness.

Solvent cycle time during manufacture of the coating composition can also affect the neutralizing effect of the coating and the light transmission properties. Specifically, as the solvent cycle time increases, the coating composition solution becomes thicker, as the viscosity of the solution increases, and thus the ultimate thickness of the coating increases. This, in turn, increases the color neutralizing effect of the coating and decreases its light transmission properties.

Determining the specific concentrations of the red and blue colorants and the thickness of the applied coating to achieve the desired color correction for each commercial application, can be determined by various methods. In particular, a design of experiment (DOE) process is used for determining or estimating the particular concentration of the red and/or blue colorants and the thickness of the coating to obtain a resulting glass structure with a desired L*a*b*. A DOE process is a process known in the art for evaluating the effect or relationship among various individual parameters or variables in a system. In a particular process, a series of experiments are conducted in which each of the individual parameters are varied between end extremes, with the other parameters remaining constant. This then provides a means by which the effect of varying a particular parameter on the properties of the end composition or product can be determined.

### EXAMPLES

In the DOE of the particular embodiment, and based on preliminary tests, the ORASOL® Red G dye level was varied between 0.06 and 0.2 grams per liter of solution (g/l sol'n), the ORASOL® Blue GN dye level was varied between 0.03 and 0.1 grams per liter of solution (g/l sol'n), the solvent cycle time was varied between 0.25 and 5 minutes and the doctor roll thickness adjustment (nip adjustment) was varied between −0.03 and 0 inches.

Preliminary tests were performed on various colorants to check for solubility in the base composition and thermal stability during the curing process.

In the above, the solvent cycle time reflects the time which the composition is allowed to cycle with the machine running. In general, the longer the cycle time, the more viscous the solution becomes and thus the thicker the coating becomes. The coating in the particular embodiment and method is applied using a roll coater with a conventional doctor roll of metal and an application roller of rubber.

In roll coating, a flowable composition is applied continuously to the rubber application roller. The use of rollers to control coating thickness of a composition onto substrates is well known in the art. The thickness or nip adjustment reflects the gap between the rollers. In general, as the compression between the rollers increases (less gap), the thickness of the coating decreases. A negative value of doctor roll thickness adjustment indicates an increased compression between the rollers than a value of zero. A sheet of glass is passed beneath the rubber roller to receive a layer of the coating composition. Table 1 reflects the variance of the above parameters during the DOE model:

TABLE 1

| | A | B | C | D |
|---|---|---|---|---|
| | Red G | Blue GN | Solvent | Doctor Roll |
| Run # | Dye Level | Dye Level | Cycle Time | Thickness Adj. |
| 1 | 0.06 | 0.03 | 0.25 | −0.03 |
| 2 | 0.06 | 0.03 | 0.25 | 0 |
| 3 | 0.06 | 0.03 | 5 | −0.03 |
| 4 | 0.06 | 0.03 | 5 | 0 |
| 5 | 0.06 | 0.1 | 0.25 | −0.03 |
| 6 | 0.06 | 0.1 | 0.25 | 0 |
| 7 | 0.06 | 0.1 | 5 | −0.03 |
| 8 | 0.06 | 0.1 | 5 | 0 |
| 9 | 0.2 | 0.03 | 0.25 | −0.03 |
| 10 | 0.2 | 0.03 | 0.25 | 0 |
| 11 | 0.2 | 0.03 | 5 | −0.03 |
| 12 | 0.2 | 0.03 | 5 | 0 |
| 13 | 0.2 | 0.1 | 0.25 | −0.03 |
| 14 | 0.2 | 0.1 | 0.25 | 0 |
| 15 | 0.2 | 0.1 | 5 | −0.03 |
| 16 | 0.2 | 0.1 | 5 | 0 |
| | (g/l sol'n) | (g/l sol'n) | (min) | (inches) |

The design of experiment (DOE) results data was generated for each of the sixteen runs of Table 1 by measuring the L*a*b* of a sample of a standard green glass substrate both before and after application of a UV coating composition prepared and applied in accordance with the parameters of Table 1. Table 2 shows the L*a*b* results measured from each of the standard green glass samples both before and after application of the UV coating composition. Coating thickness data is included for the coated substrates.

TABLE 2

| | Raw Substrate | | | Coated Substrate | | | Thickness |
|---|---|---|---|---|---|---|---|
| Run # | L* | a* | b* | L* | a* | b* | Microns |
| 1 | 96.22 | −0.59 | 0 | 96.22 | −0.66 | 0.29 | 0.55 |
| 1 | 96.22 | −0.58 | 0 | 96.12 | −0.72 | 0.38 | 0.57 |
| 1 | 96.22 | −0.58 | 0 | 96.2 | −0.7 | 0.6 | 0.64 |
| 2 | 96.21 | −0.57 | 0.01 | 96.17 | −0.77 | 0.57 | 1.58 |
| 2 | 96.21 | −0.57 | 0.01 | 96.13 | −0.83 | 0.71 | 1.6 |
| 2 | 96.21 | −0.58 | 0 | 95.97 | −0.86 | 0.78 | 1.54 |
| 3 | 96.21 | −0.58 | 0 | 96.1 | −0.78 | 0.53 | 0.97 |
| 3 | 96.22 | −0.57 | 0 | 96.17 | −0.81 | 0.6 | 1.06 |
| 3 | 96.22 | −0.57 | 0 | 96.07 | −0.74 | 0.5 | 1 |
| 4 | 96.22 | −0.58 | 0 | 96.08 | −0.91 | 0.87 | 2.15 |
| 4 | 96.22 | −0.58 | 0 | 96.09 | −0.97 | 0.98 | 2.1 |
| 4 | 96.24 | −0.57 | 0 | 96.06 | −0.94 | 0.93 | 2.17 |
| 5 | 96.24 | −0.58 | 0 | 96.2 | −0.77 | 0.38 | 0.58 |
| 5 | 96.24 | −0.58 | 0 | 96.17 | −0.75 | 0.36 | 0.51 |
| 5 | 96.24 | −0.58 | 0 | 96.13 | −0.73 | 0.36 | 0.59 |
| 6 | 96.24 | −0.58 | 0 | 96.11 | −0.95 | 0.73 | 1.4 |
| 6 | 96.24 | −0.58 | 0 | 95.98 | −0.78 | 0.4 | 1.36 |
| 6 | 96.24 | −0.58 | 0 | 96.1 | −0.82 | 0.49 | 1.4 |
| 7 | 96.24 | −0.58 | 0 | 96.15 | −0.84 | 0.5 | 0.98 |
| 7 | 96.24 | −0.58 | 0 | 96.06 | −0.82 | 0.51 | 1.08 |
| 7 | 96.24 | −0.58 | 0 | 96.14 | −0.78 | 0.4 | 1.05 |
| 8 | 96.15 | −0.7 | −0.02 | 95.92 | −1.13 | 0.77 | 2 |
| 8 | 96.15 | −0.7 | −0.02 | 95.89 | −1.12 | 0.77 | 2.15 |
| 8 | 96.15 | −0.7 | −0.02 | 96.06 | −1.05 | 0.58 | 2.13 |
| 9 | 96.13 | −0.693 | −0.02 | 96.01 | −0.86 | 0.48 | 0.55 |
| 9 | 96.13 | −0.693 | −0.02 | 96.22 | −0.93 | 0.35 | 0.65 |
| 9 | 96.13 | −0.693 | −0.02 | 96.17 | −0.96 | 0.38 | 0.62 |
| 10 | 96.13 | −0.693 | −0.02 | 95.69 | −0.71 | 0.53 | 1.81 |
| 10 | 96.13 | −0.693 | −0.02 | 95.7 | −0.77 | 0.61 | 1.66 |
| 10 | 96.13 | −0.693 | −0.02 | 95.76 | −0.79 | 0.63 | 1.71 |
| 11 | 96.13 | −0.693 | −0.02 | 96.13 | −0.61 | 0.25 | 1.14 |
| 11 | 96.13 | −0.693 | −0.02 | 95.9 | −0.8 | 0.56 | 1.14 |
| 11 | 96.13 | −0.693 | −0.02 | 95.9 | −0.78 | 0.56 | 1.09 |
| 12 | 96.13 | −0.693 | −0.02 | 95.73 | −0.71 | 0.64 | 2.46 |
| 12 | 96.13 | −0.693 | −0.02 | 95.81 | −0.63 | 0.45 | 2.08 |
| 12 | 96.13 | −0.693 | −0.02 | 95.77 | −0.64 | 0.49 | 2.51 |
| 13 | 96.14 | −0.693 | −0.02 | 96.13 | −0.88 | 0.34 | 0.63 |
| 13 | 96.14 | −0.693 | −0.02 | 96.24 | −0.62 | 0.19 | 0.64 |
| 13 | 96.14 | −0.693 | −0.02 | 96.13 | −0.65 | 0.3 | 0.65 |
| 14 | 96.14 | −0.693 | −0.02 | 95.92 | −0.81 | 0.41 | 1.49 |
| 14 | 96.14 | −0.693 | −0.02 | 95.96 | −0.82 | 0.42 | 1.53 |
| 14 | 96.14 | −0.693 | −0.02 | 95.97 | −0.81 | 0.42 | 1.49 |
| 15 | 96.14 | −0.693 | −0.02 | 95.89 | −0.91 | 0.58 | 1.22 |
| 15 | 96.14 | −0.693 | −0.02 | 95.87 | −0.87 | 0.53 | 1.24 |
| 15 | 96.14 | −0.693 | −0.02 | 96.1 | −0.69 | 0.2 | 1.12 |
| 16 | 96.14 | −0.693 | −0.02 | 95.82 | −0.7 | 0.26 | 2.27 |
| 16 | 96.14 | −0.693 | −0.02 | 95.52 | −0.81 | 0.54 | 2.27 |
| 16 | 96.14 | −0.693 | −0.02 | 95.45 | −0.77 | 0.45 | 2.5 |

The coatings on the glass substrates were cured at 450° F. for 5-6 minutes. For each run number listed in Table 2 measurements of L*, a*, b* and cured coating thickness were taken from three different samples of coated glass made utilizing the parameters for each run set forth in Table 1.

The spectrophotometer used to measure the L*a*b* values was a HUNTERLAB™ UltraScan XE Colorimeter, available from Hunter Associates Laboratory, Reston, Va,

The equipment used to coat the UV coating composition onto the glass was a custom made research coater, available from Black Brothers, Mendota, Ill.

This data was then analyzed using conventional DOE software known as DOE Pro XL software. DOE Pro XL, available from Digital Computations, Inc, is add-on software designed to work within MICROSOFT® Excel 97 spreadsheet software or later editions, available from Microsoft, corporation, Redmond, Wash. Based on the results of this regression analysis, it was predicted that a dye ratio of about 3.75 parts (0.225 g/l sol'n) ORASOL® Red G dye and about 1.0 parts (0.06 g/l sol'n) ORASOL® Blue GN dye at a dye weight percent in the composition of about 0.005 weight percent would give a coating with an L*=about 95.7, an a*=about −0.7 and a b*=about +0.4, at a cured thickness of about 2.1 microns. This compares favorably to the L*a*b* of clear glass coated with a similar UV coating.

A DOE was also performed on a production coater by generating data based on procedures similar to that above. The effects of varying the process parameters of the doctor roll thickness and cure temperature on the coated glass were measured utilizing the coating composition's dye ratio and concentration outlined above. Table 3 shows the production process parameters for each run.

TABLE 3

| | A | B |
|---|---|---|
| | Doctor Roll | Cure |
| Run # | Thickness Adj. | Temperature |
| 1 | −500 | 380 |
| 2 | −500 | 460 |
| 3 | 0 | 380 |
| 4 | 0 | 460 |
| 5 | −250 | 420 |
| 6 | −250 | 420 |
| 7 | −250 | 420 |
| 8 | −250 | 420 |
| 9 | −250 | 420 |
| 10 | −500 | 420 |
| 11 | 0 | 420 |
| 12 | −250 | 380 |
| 13 | −250 | 460 |
| | (0.0001 | (° F.) |
| | inches) | |

Table 4 shows the results measured from each of the samples obtained from the thirteen runs.

TABLE 4

| | | | | Thickness | UV Blocking |
|---|---|---|---|---|---|
| Run # | L* | a* | b* | (Microns) | (%) |
| 1 | 95.26 | −0.81 | 0.21 | NA | 97.44 |
| 1 | 95.81 | −0.76 | 0.42 | 1.39 | 97.5 |
| 1 | 95.86 | −0.74 | 0.5 | 1.42 | 97.59 |
| 1 | 95.83 | −0.73 | 0.45 | 1.4 | 97.51 |
| 1 | 95.87 | −0.81 | 0.5 | NA | 97.53 |
| 1 | 95.87 | −0.74 | 0.46 | 1.37 | 97.51 |
| 1 | 95.89 | −0.75 | 0.48 | 1.48 | 97.6 |
| 1 | 95.81 | −0.69 | 0.48 | 1.5 | 97.8 |
| 1 | 95.89 | −0.6 | 0.49 | NA | 97.05 |
| 2 | 95.55 | −0.69 | 0.11 | 1.55 | 96.43 |
| 2 | 95.88 | −0.6 | 0.33 | 1.75 | 96.32 |
| 2 | 95.83 | −0.63 | 0.28 | NA | 96.2 |
| 2 | 95.84 | −0.62 | 0.39 | 1.68 | 96.7 |
| 2 | 95.88 | −0.65 | 0.38 | 1.58 | 96.39 |
| 2 | 95.87 | −0.6 | 0.38 | 1.83 | 96.86 |
| 2 | 95.82 | −0.65 | 0.26 | 1.65 | 96.13 |
| 2 | 95.8 | −0.64 | 0.26 | 1.67 | 96.58 |
| 2 | 95.84 | −0.65 | 0.31 | NA | 96.58 |
| 3 | 95.4 | −0.81 | 0.36 | 1.88 | 99.17 |
| 3 | 95.71 | −0.79 | 0.54 | 2.01 | 98.96 |
| 3 | 95.7 | −0.75 | 0.56 | 1.99 | 99.08 |
| 3 | 95.72 | −0.76 | 0.61 | 1.93 | 99.07 |
| 3 | 95.73 | −0.8 | 0.59 | 1.92 | 99.18 |
| 3 | 95.78 | −0.73 | 0.5 | 1.87 | 98.61 |
| 3 | 95.47 | −0.75 | 0.55 | 1.87 | 99.02 |
| 3 | 95.67 | −0.76 | 0.48 | 2.01 | 98.9 |
| 3 | 95.68 | −0.77 | 0.58 | 1.98 | 98.91 |
| 4 | 95.47 | −0.71 | 0.28 | 2.33 | 98.78 |
| 4 | 95.67 | −0.69 | 0.41 | 2.08 | 98.19 |
| 4 | 95.68 | −0.63 | 0.35 | 1.96 | 98.31 |
| 4 | 95.68 | −0.63 | 0.34 | 2.19 | 98.34 |
| 4 | 95.7 | −0.7 | 0.42 | 2.09 | 98.7 |
| 4 | 95.7 | −0.64 | 0.31 | 2.04 | 97.95 |
| 4 | 95.74 | −0.64 | 0.36 | 2.17 | 98.09 |
| 4 | 95.7 | −0.66 | 0.33 | 2.19 | 98.41 |
| 4 | 95.65 | −0.66 | 0.38 | 2.16 | 98.47 |
| 5 | 95.54 | −0.75 | 0.29 | 1.69 | 97.77 |
| 5 | 95.82 | −0.7 | 0.41 | 1.81 | 97.89 |
| 5 | 95.76 | −0.7 | 0.39 | 1.82 | 97.77 |
| 5 | 95.78 | −0.71 | 0.45 | 1.81 | 98.09 |
| 5 | 95.86 | −0.77 | 0.44 | 1.48 | 97.74 |
| 5 | 95.74 | −0.72 | 0.43 | 1.79 | 97.69 |
| 5 | 95.79 | −0.72 | 0.41 | 1.76 | 98.07 |
| 5 | 95.81 | −0.74 | 0.38 | 1.73 | 97.78 |
| 5 | 95.85 | −0.72 | 0.4 | 1.55 | 97.33 |
| 6 | 95.54 | −0.76 | 0.29 | 1.64 | 97.77 |
| 6 | 95.78 | −0.7 | 0.46 | 1.55 | 98.13 |
| 6 | 95.42 | −0.67 | 0.41 | 1.8 | 97.6 |
| 6 | 95.81 | −0.69 | 0.4 | 1.69 | 98.24 |
| 6 | 95.82 | −0.76 | 0.5 | 1.46 | 97.88 |
| 6 | 95.83 | −0.68 | 0.41 | 1.85 | 97.72 |
| 6 | 95.82 | −0.71 | 0.44 | 1.76 | 98.13 |
| 6 | 95.79 | −0.7 | 0.42 | 1.8 | 97.84 |
| 6 | 95.88 | −0.73 | 0.47 | 1.44 | 97.52 |
| 7 | 95.54 | −0.77 | 0.29 | 1.45 | 97.96 |
| 7 | 95.77 | −0.71 | 0.44 | 1.91 | 98.22 |
| 7 | 95.81 | −0.68 | 0.39 | 1.7 | 97.64 |
| 7 | 95.8 | −0.72 | 0.47 | 1.57 | 98.2 |
| 7 | 95.81 | −0.74 | 0.49 | 1.56 | 97.68 |
| 7 | 95.74 | −0.71 | 0.42 | 1.79 | 97.87 |
| 7 | 95.82 | −0.7 | 0.42 | 1.93 | 97.91 |
| 7 | 95.81 | −0.72 | 0.44 | 1.74 | 97.36 |
| 7 | 95.8 | −0.72 | 0.45 | 1.49 | NA |
| 8 | 95.66 | −0.72 | 0.45 | 1.67 | 97.93 |
| 8 | 95.77 | −0.69 | 0.42 | 1.57 | 98.03 |
| 8 | 95.87 | −0.73 | 0.36 | 1.82 | 97.58 |
| 9 | 95.72 | −0.74 | 0.52 | 1.66 | 97.74 |
| 9 | 95.83 | −0.69 | 0.4 | 1.89 | 97.84 |
| 9 | 95.73 | −0.7 | 0.45 | 1.75 | 97.82 |
| 9 | 95.79 | −0.74 | 0.49 | 1.43 | 98.15 |
| 9 | 95.73 | −0.76 | 0.55 | 1.53 | 97.91 |
| 9 | 95.81 | −0.71 | 0.44 | 1.71 | 97.95 |
| 9 | 95.72 | −0.69 | 0.38 | 1.8 | 97.62 |
| 9 | 95.81 | −0.72 | 0.45 | 1.73 | 98.08 |
| 9 | 95.8 | −0.71 | 0.44 | 1.63 | 97.16 |
| 10 | 95.88 | −0.67 | 0.37 | 1.65 | 97.1 |
| 10 | 95.68 | −0.71 | 0.43 | 1.58 | 97.03 |
| 10 | 95.85 | −0.65 | 0.29 | 1.49 | 96.97 |
| 11 | 95.36 | −0.77 | 0.33 | 2.04 | 99.04 |
| 11 | 95.75 | −0.7 | 0.45 | 1.88 | 98.5 |
| 11 | 95.71 | −0.69 | 0.47 | 1.95 | 98.53 |
| 11 | 95.68 | −0.73 | 0.53 | 2.04 | 99 |
| 11 | 95.55 | −0.71 | 0.57 | 1.93 | 98.96 |
| 11 | 95.72 | −0.68 | 0.39 | 1.92 | 98.14 |
| 11 | 95.72 | −0.69 | 0.42 | 1.84 | 98.48 |
| 11 | 95.71 | −0.71 | 0.47 | 2.04 | 98.84 |
| 11 | 95.46 | −0.72 | 0.49 | 2.01 | 98.85 |
| 12 | 95.39 | −0.79 | 0.4 | 1.7 | 98.66 |
| 12 | 95.77 | −0.79 | 0.5 | 1.79 | 98.89 |
| 12 | 95.76 | −0.75 | 0.54 | 1.83 | 99.07 |
| 12 | 95.77 | −0.77 | 0.61 | 1.76 | 99.02 |
| 12 | 95.77 | −0.81 | 0.54 | 1.59 | 99.02 |
| 12 | 95.75 | −0.73 | 0.49 | 1.74 | 98.53 |
| 12 | 95.8 | −0.76 | 0.56 | 1.72 | 98.86 |
| 12 | 95.76 | −0.76 | 0.47 | 1.69 | 98.54 |
| 12 | 95.79 | −0.76 | 0.57 | 1.63 | 98.71 |
| 13 | 95.64 | −0.69 | 0.29 | 1.91 | 98.18 |
| 13 | 95.74 | −0.66 | 0.3 | 2.12 | 98.05 |
| 13 | 95.73 | −0.59 | 0.23 | 1.63 | 97.8 |
| 13 | 95.74 | −0.62 | 0.33 | 1.89 | 98.08 |
| 13 | 95.66 | −0.7 | 0.38 | NA | 98.16 |
| 13 | 95.73 | −0.64 | 0.28 | 2.09 | 97.62 |
| 13 | 95.65 | −0.61 | 0.43 | 2.03 | 98.01 |
| 13 | 95.68 | −0.64 | 0.36 | 2.03 | 98.17 |
| 13 | 95.74 | −0.67 | 0.37 | 1.88 | 98.25 |

For each run number listed in Table 4 measurements of L*, a*, b* of the coated glass substrate, cured coating thickness and UV blocking percentage were taken from three to nine different samples of coated glass made utilizing the parameters for each run set forth in Table 3.

The percentage of UV blocking is calculated by measuring the transmission (% T) of the coated glass over the wavelength range of 300 nm-380 mn. Measurements are made at 1 nm increments. The transmission measurements are then averaged together and the resulting average transmission is subtracted from 100% to give the UV blocking percentage value. For example, a sample might have an average transmission of 1.5% from 300-380 nm which equates to 98.5% UV blocking value. Generally, an acceptable UV blocking percentage is about 98% or greater and in particular about 98.5%. The UV blocking percentage can be measured with a spectrometer that is capable of measuring % transmission of a solid sample in the 300-380 nm wavelength range. One such instrument is a PERKINELMER™ Lambda 35 UV/VIS Spectrometer available from PerkinElmer, Inc., Wellesley, Mass.

This data was similarly analyzed using DOE Pro XL software. For one of the runs in which the cured coating thickness was about 2.1 microns, the average L*a*b* values were L*=about 95.6, a*=about −0.7 and b*=about +0.5. Using the parameters from this run in a pilot production run, and then making various further adjustments to the dye concentrations to achieve desired L*a*b* values, production quantities of UV coated standard green glass were produced. The coating composition for these production quantities contained red and blue dyes in a ratio of 3.75 parts (0.225 g/l sol'n) ORASOL® Red G dye and 1.0 parts (0.06 g/l sol'n) ORASOL® Blue GN dye at a dye weight percent in the composition of about 0.005 weight percent. The coating was applied at a cured thickness of about 2.4 microns. The L*a*b* values for these production quantities were L*=about 95.8, a*=about −0.6 and b*=about +0.9. These L*a*b* values compare favorably to the L*a*b* values of clear glass coated with a conventional UV coating as set forth above.

Accordingly, the present invention relates to a glass structure including a standard glass substrate (particularly a standard green glass substrate) which is provided with a coating (particularly a UV or other coating) containing a dye or combination of dyes to at least partially neutralize the off-neutral color of the underlying glass substrate. Particularly, the UV coated glass in accordance with the invention has an L*a*b* at least comparable to UV coated glass, namely an L*a*b* with L* particularly being greater than about 94.0 and more particularly greater than about 95.0, with a* particularly more neutral than about −1.0 and more particularly more neutral than about −0.9 and with b* particularly more neutral than about +1.5, more particularly more neutral than about +1.3 and in one embodiment more neutral than about +1.1. To achieve these values, the coating composition contains in particular a combination of red and blue dyes in which the concentration of the red dye is greater than the concentration of the blue dye, more particularly in which the concentration of the red dye is at least twice the concentration of the blue dye and in one embodiment in which the concentration of the red dye is at least about three times the concentration of the blue dye.

Although the present invention has been described with reference to particular embodiments, persons skilled in the art will recognize that changes may be made in form and detail without departing from the spirit and scope of the invention. All references cited throughout the specification, including those in the background, are incorporated herein in their entirety. Those skilled in the art will recognize, or be able to ascertain, using no more than routine experimentation, many equivalents to specific embodiments of the invention described specifically herein. Such equivalents are intended to be encompassed in the scope of the following claims.

What is claimed is:

1. A method of making a coated glass structure comprising:
providing a glass substrate wherein the glass substrate exhibits a color which is off neutral; and
applying a coating to the glass substrate wherein the coating comprises a colorant capable of at least partially neutralizing the color.

2. The method of claim 1, wherein the colorant comprises one or more dyes.

3. The method of claim 2, wherein one or more dyes comprises a cobalt complex.

4. The method of claim 3, wherein the cobalt complex dye has Colour Index number Solvent Red 125.

5. The method of claim 2, wherein one or more dyes comprises a copper phthalocyanine.

6. The method of claim 5, wherein the copper phthalocyanine dye has Colour Index number Solvent Blue 67.

7. The method of claim 1, wherein the colorant comprises a mixture of dyes comprising a dye with Colour Index Solvent Blue 67 and a dye with Colour Index Solvent Red 125.

8. The method of claim 1, wherein the coating is a polysiloxane resin.

9. The method of claim 8, wherein the polysiloxane resin comprises an ultraviolet-absorbing material.

10. The method of claim 8, wherein the polysiloxane resin comprises a condensate of colloidal silica, CH₃Si(OCH₃)₃ and

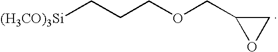

11. The method of claim 9, wherein the ultraviolet-absorbing material is a benzophenone.

12. The method of claim 9, wherein the ultraviolet-absorbing material is a benzophenone and the polysiloxane resin comprises a condensate of colloidal silica, CH₃Si(OCH₃)₃ and

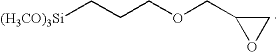

13. The method of claim 12, wherein the colorant comprises a mixture of dyes comprising a dye with Colour Index Solvent Blue 67 and a dye with Colour Index Solvent Red 125.

14. The method of claim 1, further comprising the steps:
determining the color of the glass substrate; and
determining the colorant needed to at least partially neutralize the color.

15. The method of claim 1, wherein the coating is an ultraviolet radiation blocking coating.

16. The method of claim 15, wherein the coating includes colorant in an amount effective for the coated glass structure to have an L*a*b* wherein L* is greater than about 95.

17. The method of claim 15, wherein the coating comprises colorant in an amount effective for the coated glass structure to have an L*a*b* wherein a* is more neutral than about −1.0.

18. The method of claim 15, wherein the coating comprises colorant in an amount effective for the coated glass structure to have an L*a*b* wherein b* is more neutral than about +1.1.

19. The method of claim 16, wherein a* is more neutral than about−1.0 and b* is more neutral than about +1.1.

20. The method of claim 15, wherein the coating further comprises a colorant capable of at least partially neutralizing the inherent color of the ultraviolet radiation blocking coating.

21. The method of claim 1, wherein the colorant includes a combination of red and blue dyes wherein the concentration of red dye in the coating is greater than the concentration of blue dye in the coating.

22. The method of claim 21, wherein the concentration of red dye in the coating is at least twice as great as the concentration of blue dye in the coating.

23. The method of claim 1, wherein the substrate and the coating are substantially transparent.

24. A glass structure comprising:
a glass substrate having a pair of major surfaces wherein the glass substrate exhibits a color which is off neutral; and
a coating applied to at least one of the major surfaces wherein the coating exhibits a color which at least partially neutralizes the color of the glass substrate.

25. The glass structure of claim 24, wherein the glass substrate and the coating are substantially transparent.

26. The glass structure of claim 24, wherein the coating comprises a colorant to at least partially neutralize the color of the glass substrate.

27. The glass structure of claim 24, wherein the coating is an ultraviolet blocking coating.

28. The glass structure of claim 27, wherein the coating comprises colorant in an amount effective for the coated glass structure to have an L*a*b* wherein L* is greater than about 95.

29. The glass structure of claim 28, wherein the coating comprises colorant in an amount effective for the coated glass structure to have an L*a*b* wherein a* is more neutral than about −1.0.

30. The glass structure of claim 29, wherein the coating comprises colorant in an amount effective for the coated glass structure to have an L*a*b* wherein b* is more neutral than about +1.1.

31. The glass structure of claim 27, wherein a* is more neutral than about −1.0 and b* is more neutral than about +1.1.

32. The glass structure of claim 24, wherein the coating is a polysiloxane resin.

33. The glass structure of claim 32, wherein the polysiloxane resin comprises an ultraviolet-absorbing material.

34. The glass structure of claim 32, wherein the polysiloxane resin comprises a condensate of colloidal silica, CH₃Si(OCH₃)₃ and

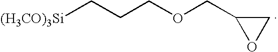

35. The glass structure of claim 33, wherein the ultraviolet-absorbing material is a benzophenone.

36. The glass structure of claim 33, wherein the ultraviolet-absorbing material is a benzophenone and the polysiloxane resin comprises a condensate of colloidal silica, CH₃Si(OCH₃)₃ and

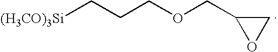

37. The glass structure of claim 36, wherein the colorant comprises a mixture of dyes comprising a dye with Colour Index Solvent Blue 67 and a dye with Colour Index Solvent Red 125.
